(19) United States
(12) Patent Application Publication
(10) Pub. No.: US 2010/0018093 A1
(43) Pub. Date: Jan. 28, 2010

(54) SEGMENTED GRAPHIC DISPLAY FOR A SECTIONAL OVERHEAD GARAGE DOOR

(75) Inventor: D. Patrick O'Sullivan, Winston-Salem, NC (US)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Amarr Company, Winston-Salem, NC (US)

(21) Appl. No.: 12/177,980

(22) Filed: Jul. 23, 2008

(51) Int. Cl. G09F 7/04

(52) U.S. Cl. 40/600

(57) ABSTRACT

A selectively removable graphic display for a sectional overhead garage door of a type including at least first and second pivotally connected horizontal steel door panels having respective first and second widths, respective first and second outer faces, and a first elongated horizontal joint therebetween. The display includes a first sheet segment having a first magnetic inner face, a first outer display face, a first outer shape having a first straight edge, and a first height. The first height is less than or substantially equal to the first width of the first door panel. A second sheet segment includes a second magnetic inner face, a second outer display face, a second outer shape having a second straight edge, and a second height that is substantially equal to the second width of the second door panel. The first and second shapes combine to form an overall shape, such as a logo.

### FIELD OF THE INVENTION

The invention relates to graphic displays, and more particularly relates to a selectively removable and reusable segmented graphic display for a sectional overhead garage door.

### BACKGROUND

Sectional overhead garage doors are commonly used for garage entryways. Such doors typically include a plurality of rectangular door panels or door sections that are pivotally interconnected in series by a plurality of interior hinges. Often, the door sections are constructed of sheet metal, such as steel, and include substantially planar outer faces. The outer faces of the door sections often include columns and rows of embossed patterns, such as embossed rectangular panels, or the like. The door panels include spaced rollers on their ends that are received in roller tracks positioned along each side of a door frame of a garage entryway. Each roller track is substantially L-shaped, and includes an elongated vertical portion that extends along an interior side of a door frame side jamb, an elongated inwardly extending portion that substantially horizontally extends into the garage at an elevation that is above the top of the door frame, and a curved transition portion that extends between the vertical portion and the inwardly extending portion. The rollers and roller tracks guide the door panels between their closed and open positions.

In a closed position, the roller tracks support the door sections in a vertical plane such that the panels combine to cover the entryway. When the door is closed, the horizontal edges of adjacent door panels are in close proximity to each other, and define narrow horizontally extending gaps between the outer faces of the sections. As the door is opened, the vertical portions of the roller tracks guide the rollers and door sections vertically upward. The curved transition portion of the track then causes each door section to move from a vertical orientation to a horizontal orientation until the rollers of all door sections are engaged in the inwardly extending portion of the roller track, and the entire door is positioned above the entryway. As the door is closed, the rollers and tracks cooperate to guide all of the door sections back to there vertical positions. Because the hinged door sections pivot relative to each other as the door moves between its open and closed positions, the gaps between the outer faces of adjacent door sections increase in width as the door is lifted.

### SUMMARY

In one embodiment, the invention includes a selectively removable graphic display for a sectional overhead garage door of a type including at least first and second pivotally connected horizontal steel door panels having respective first and second widths, respective first and second outer faces, and a first elongated horizontal joint therebetween. In this embodiment, the display includes a first sheet segment having a first magnetic inner face, a first outer display face, a first outer shape having a first straight edge, and a first height, the first height being less than or substantially equal to the first width of the first door panel; and a second sheet segment having a second magnetic inner face, a second outer display face, a second outer shape having a second straight edge, and a second height, the second height being less than or substantially equal to the second width of the second door panel. The display is configured such that when the first inner face of the first sheet segment is magnetically attached to the first outer face of the first door panel such that the first straight edge is proximate to the horizontal joint, and the second inner face of the second sheet segment is magnetically attached to the second outer face of the second door panel such that the second straight edge is proximate to the first horizontal joint and the second sheet segment is aligned with the first sheet segment, the first and second outer shapes cooperate to form a substantially continuous combined outer shape when the garage door is in a closed position.

In another embodiment, the invention includes a selectively removable graphic display for a sectional overhead garage door of a type including at least first and second pivotally connected horizontal steel door panels having respective first and second heights, and respective first and second outer faces with a first elongated horizontal joint therebetween. In this embodiment, the graphic display includes a first sheet of material having a first magnetic surface, a first outer shape including an elongated first edge, a first display surface opposite the first magnetic surface, and a first width that is not greater than the first height of the first door panel; and a second sheet of material having a second magnetic surface, a second outer shape including an elongated second edge, a second display surface opposite the second magnetic surface, and a second width that is less than or substantially equal to the second height of the second door panel. The first magnetic surface of the first sheet of material is configured to be magnetically attached to the first outer face of the first door panel such that the first edge is substantially proximate to and substantially parallel to the first horizontal joint, and the second magnetic surface of the second sheet of material is configured to be magnetically attached to the second outer face of the second door panel such that the second edge is substantially proximate to and substantially parallel to the first horizontal joint, and such that the second outer shape is substantially aligned with the first outer shape. The substantially aligned first and second outer shapes cooperate to form a substantially continuous combined outer shape when the garage door is in a closed position.

In a further embodiment, the invention includes a method of producing a multi-segment removable graphic display for a sectional overhead garage door of a type that includes at least first and second pivotally connected horizontal door panels separated by an elongated horizontal joint. In this embodiment, the method includes providing a first sheet having a first magnetic face, an opposed first display face, and a first margin extending along a first edge portion of the first display face, and printing a first pattern on the first display surface such that at least a portion of the first pattern is printed on at least a portion of the first margin. The method further includes severing the first margin and a portion of the first pattern thereon from the first sheet to form a first severed edge, and trimming the first sheet to have a first shape. The method also includes providing a second sheet having a second magnetic face, an opposed second display face, and a second margin extending along a second edge portion of the second display face; printing a second pattern on the second display surface such that at least a portion of the second pattern is printed on at least a portion of the second margin; severing the second margin and a portion of the second pattern thereon from the second sheet to form a second severed edge; and trimming the second sheet to have a second shape. When the first sheet is magnetically attached to a first outer face of the first door panel such that the first severed edge is proximate to the horizontal joint, and the second sheet is magnetically attached to a second outer face of the second door panel such that the second severed edge is proximate to the horizontal joint and the second sheet is aligned with the first sheet, the first and second shapes cooperate to form a combined outer shape and the remaining portions of the first and second patterns cooperate to form a substantially continuous combined pattern when the garage door is in a closed position.

These and other aspects and features of the invention will be understood from a reading of the following description together with the drawings.

### BRIEF DESCRIPTION OF THE DRAWINGS

FIG. 1 is a perspective environmental view of one embodiment of a segmented graphic display mounted on an outer face of a typical sectional overhead garage door.

FIG. 2 is a perspective environmental view of another embodiment of a segmented graphic display mounted on an outer face of a typical sectional overhead garage door.

FIG. 3A is a plan view of a first printed sheet for producing an upper first portion of the segmented graphic display shown in FIG. 1.

FIG. 3B is a plan view of a second printed sheet for producing a lower second portion of the segmented graphic display shown in FIG. 1.

FIG. 4A is a plan view of the upper first portion of the segmented graphic display shown in FIG. 1 after cutting from the first printed sheet.

FIG. 4B is a plan view of the lower second portion of the segmented graphic display shown in FIG. 1 after cutting from the second printed sheet.

FIG. 5 is a plan view of the first upper portion shown in FIG. 4A and the second lower portion shown in FIG. 4B combined to form the segmented graphic display shown in FIG. 1.

FIG. 6 is a cross-sectional view of portions of the sectional overhead garage door and segmented graphic display taken along line 6-6 in FIG. 1 with the door in a partially open configuration.

### DETAILED DESCRIPTION

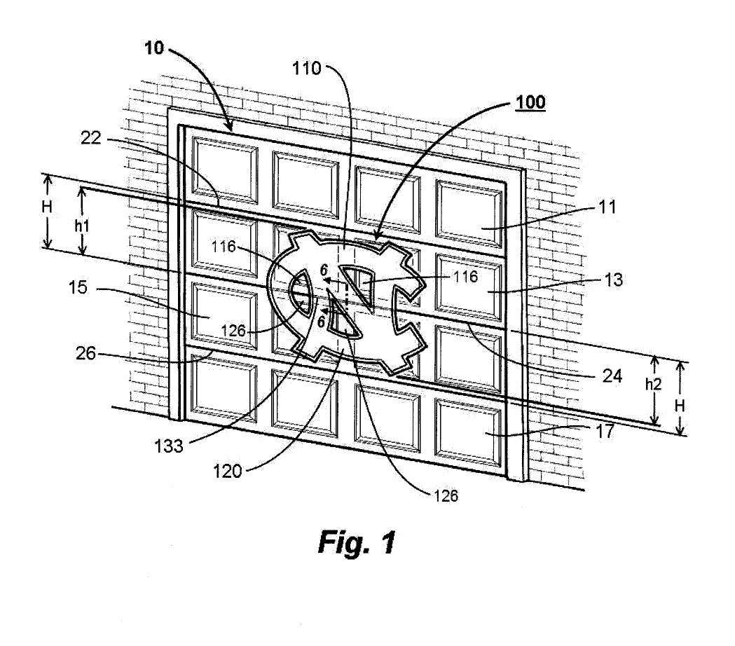

One embodiment of segmented graphic display 100 according to the invention is shown in FIG. 1. In FIG. 1, the segmented graphic display 100 is removably attached to the outer face of a typical steel sectional overhead garage door 10. The door 10 includes four elongated rectangular panels, including an uppermost first panel 11, an intermediate second panel 13, an intermediate third panel 15, and a lowermost fourth panel 17. Though not shown in FIG. 1, the door panels 11, 13, 15 and 17 are pivotally interconnected by a plurality of interior hinges. In the closed position shown in FIG. 1, the lower outer edge of the first panel 11 abuts the upper outer edge of the second panel 13, forming a narrow first horizontal joint 22 therebetween. Similarly, a narrow second horizontal joint 24 extends between adjacent outer edges of the second panel 13 and the third panel 15, and a narrow third horizontal joint 26 extends between the adjacent outer edges of the third panel 15 and third panel 15. In a typical modern sectional overhead door, the horizontal joints 22, 24 and 26 are each about ⅛-inch wide, depending on door design and installation. As shown in FIG. 1, the four door panels 11, 13, 15 and 17 have equal heights “H”.

In FIG. 1, the segmented graphic display 100 is removably attached to portions of the outer faces of the second and third door panels 13, 15. In one embodiment, as further described below, the inner surface of the segmented graphic display 100 is magnetic, and the segmented graphic display 100 is removably and magnetically attached the outer faces of the second and third door panels 13, 15. The segmented graphic display 100 includes an upper segment 110 and a lower segment 120. A lower edge of the upper segment 110 meets an upper edge of the lower segment 120 along a horizontal seam 133. As shown in FIG. 1, the upper segment 110 and lower segment 120 are mounted on the door 10 such that the horizontal seam 133 coincides with the horizontal joint 24 between the second door panel 13 and the third door panel 15. Alternatively, the segmented graphic display 100 can be mounted on the door 10 such that the horizontal seam 133 coincides with either of the other two horizontal joints 22, 26. As shown in FIG. 1, the upper segment 110 has a height “h1” and the lower segment 120 has a height “h2”, both of which are less than or substantially equal to than the height “H” of the same-size door segments 11, 13, 15 and 17. In order to maximize the size of the graphic display 100, the heights h1 and h2 of the upper and lower segments 110, 120 can be substantially equal to the height H of the door panels 11, 13, 15 and 17.

In the embodiment shown in FIG. 1, the segmented graphic display 100 has the shape and visual features of a college logo. In the specific example shown in FIG. 1, the segmented graphic display 100 depicts a logo of the University of North Carolina, and includes the overlaid and stylized capital letters “N” and “C” (a registered trademark of the University of North Carolina at Chapel Hill). Alternatively, the segmented graphic display 100 can have the shape and visual details of any other desired logo, emblem, symbol, object, letter or letters, words, or the like. As further described below, substantially any image can be printed on or otherwise applied to the outer surface of the segmented graphic display 100 in substantially any color or combination of colors.

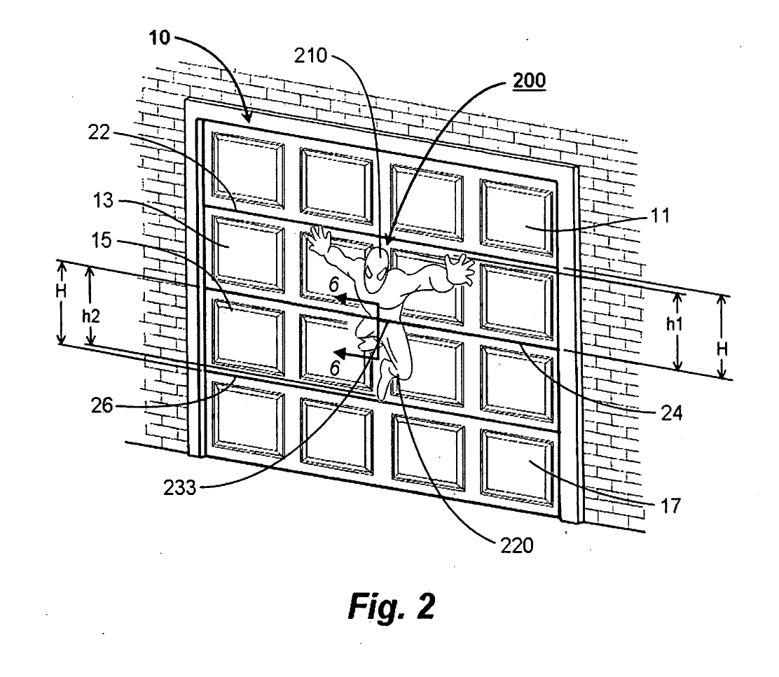

A second example of a segmented graphic display 200 according to the invention is shown in FIG. 2. In this example, the segmented graphic display 200 depicts the comic book character Spider-Man® (Spider-Man is a registered trademark of Marvel Characters, Inc.). Alternatively, the segmented graphic display 200 can depict substantially any other person, character, mascot, animal, creature, or the like, either real or imaginary. Like the first example described above and shown in FIG. 1, the segmented graphic display 200 includes an upper portion 210 and a lower portion 220 that meet along a horizontal seam 233. In FIG. 2, the horizontal seam 233 coincides with the narrow horizontal joint 24 between the second door panel 13 and the third panel 15. Alternatively, the segmented graphic display 200 can be mounted on the door 10 such that the horizontal seam 233 coincides with either of the other two horizontal joints 22, 26. Like the first example 100 described above and as shown in FIG. 2, the upper segment 210 has a height “h1” and the lower segment 220 has a height “h2”, both of which are less than or substantially equal to the height “H” of the same-size door segments 11, 13, 15 and 17. In order to maximize the size of the graphic display 200, the heights h1 and h2 of the upper and lower segments 210, 220 can be substantially equal to the height H of the door panels 11, 13, 15 and 17.

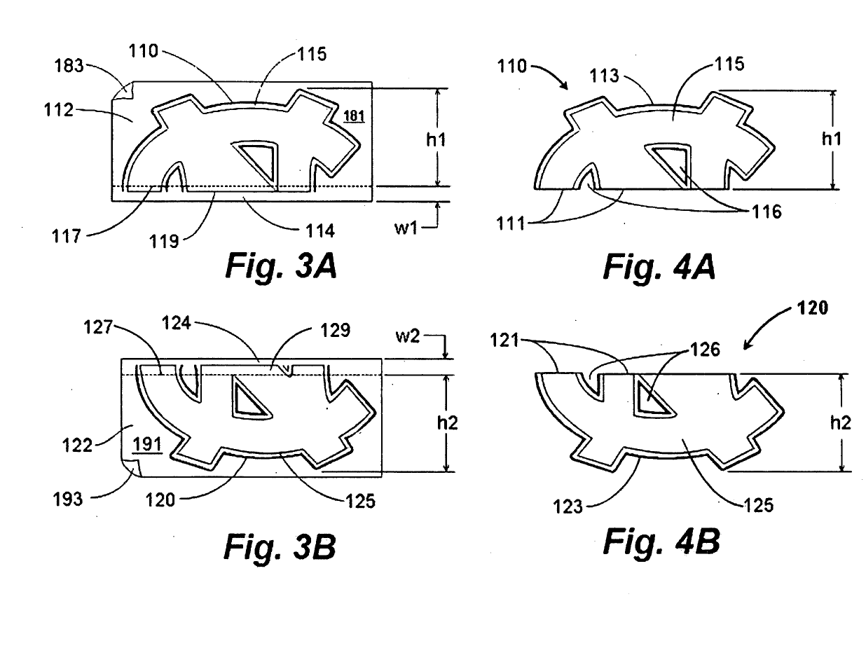

A method of producing a segmented graphic display 100 according to the invention is illustrated in FIGS. 3A-4B. As shown in FIG. 3A, a first sheet of substrate material 112 can be used to produce an upper segment 110. The first sheet 112 is wider and taller than the final upper segment 110. Preferably, the first sheet 112 is a thin and flexible sheet of a durable material, and includes an outer surface 181 that is capable of receiving a printed image 115. In one embodiment, the thickness and rigidity of the first sheet 112 is selected so as to minimize cost and maximize ease of handling, and such that the first sheet 112 is not in continuous, uninterrupted contact with the outer faces of door panels 13 and 15. In other words, the thickness can be selected such that the first sheet 112 has sufficient stiffness to span at least some recessed contours in the door panels without sagging into and fully conforming to the recessed contours. In one embodiment, the first sheet 112 has a thickness of greater than about 0.015 inch (15 mils), and preferably about 0.030 inch (30 mils). As used herein, the terms “printed image” and “printed pattern” refer to an image or pattern that is formed on or imparted to a surface by a printing process or otherwise. In one embodiment, the outer surface 181 includes a white vinyl film, and the back 183 of the first sheet 112 includes a flexible polymer resin with ferrite particles imbedded therein. The imbedded ferrite particles on the back 183 of the first sheet 112 are magnetized such that the first sheet 112 can be magnetically attached to a face of a steel garage door panel. The density of the ferrite particles and the degree of magnetization of the ferrite particles is such that at least a portion of the first sheet of material 112 can be securely magnetically attached to a surface of a steel object, such as a steel garage door panel. Preferably, the density of the ferrite particles and the degree of magnetization of the ferrite particles is such that when at least a portion of the first sheet of material 112 is magnetically attached to an outer surface of a steel garage door panel, the attached material 112 can be selectively removed, and will remained attached to the steel garage door panel when subjected to high winds and other anticipated weather conditions. As shown in FIG. 3A, a first image or pattern 115 is printed or otherwise formed on the front face 181 such that at least a marginal portion 119 of the printed image 115 extends onto a margin 114 along one edge of the sheet 112 that is defined by a straight line 117 and has a width “w1”.

As shown in FIG. 3B, a second sheet of substrate material 122 can be used to produce an upper segment 120. The second sheet 122 is wider and taller than the final upper segment 120. Preferably, the second sheet 122 is a thin and flexible sheet of a durable material, and includes an outer surface 191 that is capable of receiving a printed image 125. Like the first sheet 112, the thickness and rigidity of the second sheet 122 is selected so as to minimize cost and maximize ease of handling, and such that the second sheet 122 is not in continuous uninterrupted contact with the outer faces of door panels 13 and 15. In other words, the thickness can be selected such that the second sheet 122 has sufficient stiffness to span at least some recessed contours in the door panels without sagging into and fully conforming to the recessed contours. In one embodiment, the second sheet 112 has a thickness of greater than about 0.015 inch (15 mils), and preferably about 0.030 inch (30 mils). Like the first sheet 112 described above, the outer surface 191 can include a white vinyl film, and the back 193 can include a polymer resin with imbedded and magnetized ferrite particles. Like the first sheet 112, the density of the ferrite particles and the degree of magnetization of the ferrite particles is such that at least a portion of the second sheet of material 122 can be securely magnetically attached to a surface of a steel object, such as a steel garage door panel. Preferably, the density of the ferrite particles and the degree of magnetization of the ferrite particles is such that when at least a portion of the second sheet of material 122 is magnetically attached to an outer surface of a steel garage door panel, the attached material 122 can be selectively removed, and will remained attached to the steel garage door panel when subjected to wind and other anticipated weather conditions. As shown in FIG. 3B, a second image 125 or pattern is printed or otherwise formed on the front face 191 such that at least a marginal portion 129 of the printed image 125 extends onto a margin 124 along one edge of the sheet 122 that is defined by a straight line 127 and has a width “w2”.

After the first and second images 115, 125 have been printed or otherwise formed on the outer faces 181, 191, the first and second sheets 112, 122 can be trimmed as shown in FIGS. 4A and 4B. The lower margin 114 of the first sheet 112 (and the marginal portion 119 of the image thereon) is trimmed away to define a substantially straight lower edge 111. Similarly, the upper margin 124 of the second sheet 112 (and the marginal portion 129 of the image thereon) is trimmed away to define a substantially straight upper edge 121. Because the marginal portions 119, 129 of the printed images 115, 125 extend onto the margins 114, 124 of the sheets 112, 122, the remainders of the printed images 115, 125 extend up to the respective straight edges 111, 121 after the margins 114, 124 are removed. In addition, at least some portions of the first sheet 112 that surround the first image 115 can be cut away to provide the upper segment with a first outer edge 113 having a first outer shape. Similarly, at least some portions of the second sheet 122 that surround the second image 115 can be cut away to provide the lower segment 120 with a second outer edge 123 having a second outer shape. If desired, however, all or some portions of the sheets 122 that surround the first and second images 115, 125 other than the margins 114, 124 can be left untrimmed.

Once trimmed, the upper and lower segments 110, 120 have respective heights “h1” and “h2” that are both less than or equal to a height “H” of the panels of a garage door that will receive the upper and lower segments 110, 120. For example, each panel of a typical 7-foot four-panel overhead garage door has a height “H” of about 21 inches. Accordingly, the heights “h1” and “h2” of the upper and lower segments 110, 120 of a segmented graphic display 100 for use with such a 7-foot four-panel door would both be less than or equal to about 21 inches. In order to maximize the size of a two-segment graphic display 100 for such a door, the upper and lower segments 110, 120 can have heights “h1” and “h2” that both are substantially equal to 21 inches. Of course, for garage doors having fewer or more than four panels and/or having overall heights other than 7 feet, the heights “h1” and “h2” of the segments 110, 120 can be adjusted to be less than or equal to the specific height “H” of the corresponding door panels.

As also shown in FIGS. 4A and 4B, for a particular graphic display 100, one or more interior cutouts 116, 126 can be made in the upper and lower segments 110, 120 consistent with the configuration of the first and/or second images 115, 125. As shown in FIG. 1, underlying portions of the door 10 are visible through such interior cutouts 116, 126 when the segmented graphic display 100 is mounted on the door 10.

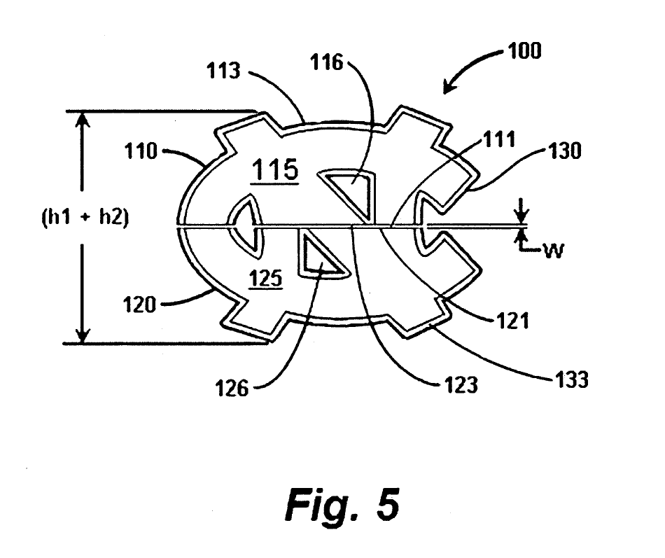

Once the upper and lower segments 110, 120 have been trimmed, the two segments can be combined to form the complete graphic display 100. As shown in FIG. 5, when the lower edge 111 of the upper segment 110 is positioned adjacent to the upper edge 121 of the lower segment 120 and the outer edge 113 of the upper segment 110 is aligned with the outer edge 123 of the lower segment, the first and second images 115, 125 cooperate to form a substantially continuous combined image. The width “w” of the horizontal seam 133 between the adjacent edges 111, 121 of the upper and lower segments 110, 120 can be minimized to make the seam 133 substantially invisible to an observer, except upon close visual inspection. Preferably, the width “w” of the seam 133 is substantially zero.

The upper and lower segments 110, 120 of the segmented graphic display 100 can be mounted on a garage door 10 as shown in FIG. 1. In this arrangement, the upper segment 110 is magnetically attached to an outer face of the second door panel 13 such that its lower edge 111 is immediately adjacent to and parallel to the lower horizontal edge of the second panel 13. The lower segment 120 is similarly magnetically attached to an outer face of the third door panel 15 such that it is aligned with the upper segment 110, and its upper edge 121 is immediately adjacent to and parallel to the upper horizontal edge of the third panel 15. As a result, the seam 133 between the upper and lower segments 110, 120 coincides with the horizontal joint 24 between the second and third door panels 13, 15. In a preferred embodiment, no portion of the upper segment 110 extends onto the third panel 15, and no portion of the lower segment 120 extends onto the second panel 13.

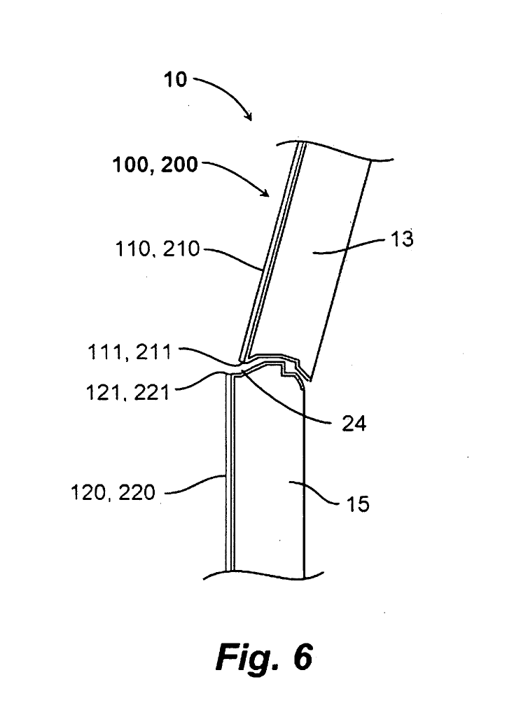

FIG. 6 is a partial cross section of the door panels 13, 15 and the mounted segmented graphic displays 100, 200 shown in FIGS. 1 and 2 with the door 10 in a partially open position. As shown in FIG. 6, as the door 10 is opened and closed, the second panel 13 is rotated inwardly relative to the pivotally connected third panel. Accordingly, the width of the horizontal joint 24 between the door panels 13, 15 increases as the angle of rotation of the second panel 13 increases. Because neither the upper segments 110, 210 nor the lower segments 120, 220 of the segmented graphic displays 100, 200 extend across the horizontal joint 24 between the door panels 13, 15, the displays 100, 200 do not restrict the relative pivoting movement between the door panels 13, 15, and thus do not interfere with the normal articulation of the door 10 as it is raised or lowered. In other words, because no segment 110, 120, 210, 220 is magnetically attached to more than a single door panel 11, 13, each segment 110, 120, 210, 220 merely follows its associated door panel 11, 13 when the door 10 is opened, and does not block or inhibit the folding movement of the panels 11, 13.

As discussed above, one embodiment of segmented graphic display includes a magnetic backing. Preferably, the magnetic backing has sufficient holding power to secure the display against wind forces and the like, yet still permits the display to be quickly and easily mounted and removed from the outer face of a garage door. Because the segmented graphic displays can be constructed of thin and flexible sheets of material, the segments can be folded for storage and/or shipment.

The above descriptions of various embodiments of the invention are provided to illustrate particular aspects and features of the invention, and not to limit the invention thereto. Persons of ordinary skill in the art will recognize that certain changes and modifications can be made to the described embodiments without departing from the invention. For example, though the embodiments of the segmented graphic display shown in the figures have widths that are substantially less than the widths of the associated garage doors, a segmented graphic display according to the invention can have substantially any width, up to and including the entire width of a garage door. In addition, for a large segmented graphic display, it is possible to provide one or more vertical seams in one or more of its large segments to facilitate handling and mounting. Also, though a segmented graphic display according to the invention preferably includes a magnetic backing for selective removable attachment to a steel garage door, the display also can be provided with an adhesive backing or another suitable means for attachment to a steel or non-steel garage door, for example. Furthermore, though a process for producing a segmented graphic display has been described wherein the printed images are formed on a substrate before the substrate is trimmed, the printed images also can be printed on pre-trimmed sheets of substrate material. All such changes and modifications are intended to be within the scope of one or more of the appended claims.

What is claimed is:

1. A selectively removable and reusable graphic display for a sectional overhead garage door of a type including at least first and second pivotally connected horizontal steel door panels having respective first and second widths, respective first and second outer faces, and a first elongated horizontal joint therebetween, the display comprising:
(a) a first sheet segment having a first magnetic inner face, a first outer display face, a first outer shape having a first straight edge, and a first height, the first height being less than or substantially equal to the first width of the first door panel;
(b) a second sheet segment having a second magnetic inner face, a second outer display face, a second outer shape having a second straight edge, and a second height, the second height being less than or substantially equal to the second width of the second door panel;
(c) wherein when the first inner face of the first sheet segment is magnetically attached to the first outer face of the first door panel such that the first straight edge is proximate to the horizontal joint, and the second inner face of the second sheet segment is magnetically attached to the second outer face of the second door panel such that the second straight edge is proximate to the first horizontal joint and the second sheet segment is aligned with the first sheet segment, the first and second outer shapes cooperate to form a substantially continuous combined outer shape when the garage door is in a closed position.

2. A graphic display according to claim 1 wherein the first outer display face includes a first printed pattern thereon and the second outer display face includes a second printed pattern thereon, and wherein when the second sheet segment is aligned with the first sheet segment, the first and second patterns cooperate to form a substantially continuous display pattern when the garage door is in a closed position.

3. A graphic display according to claim 1 wherein the combined outer shape substantially corresponds to a shape of a logo, emblem, symbol or other object.

4. A graphic display according to claim 1 wherein the combined outer shape substantially corresponds to a shape of a person, character, animal or creature.

5. A graphic display according to claim 3 wherein the combined outer shape substantially corresponds to an outer shape of a logo, emblem, or symbol of a sports team or sports organization.

6. A graphic display according to claim 1 wherein the first and second sheets comprise a flexible polymeric material.

7. A selectively removable and reusable graphic display for a sectional overhead garage door of a type including at least first and second pivotally connected horizontal steel door panels having respective first and second heights, and respective first and second outer faces with a first elongated horizontal joint therebetween, the graphic display comprising:
(a) a first sheet of material having a first magnetic surface, a first outer shape including an elongated first edge, a first display surface opposite the first magnetic surface, and a first width that is not greater than the first height of the first door panel; and
(b) a second sheet of material having a second magnetic surface, a second outer shape including an elongated second edge, a second display surface opposite the second magnetic surface, and a second width that is less than or substantially equal to the second height of the second door panel;
(c) wherein the first magnetic surface of the first sheet of material is configured to be magnetically attached to the first outer face of the first door panel such that the first edge is substantially proximate to and substantially parallel to the first horizontal joint;
(d) wherein the second magnetic surface of the second sheet of material is configured to be magnetically attached to the second outer face of the second door panel such that the second edge is substantially proximate to and substantially parallel to the first horizontal joint, and such that the second outer shape is substantially aligned with the first outer shape; and
(e) wherein the substantially aligned first and second outer shapes cooperate to form a substantially continuous combined outer shape when the garage door is in a closed position.

8. A graphic display according to claim 7 wherein the first display face includes a first printed pattern thereon and the second display face includes a second printed pattern thereon, and wherein when the second sheet is aligned with the first sheet, the first and second printed patterns cooperate to form a substantially continuous display pattern when the garage door is in a closed position.

9. A graphic display according to claim 7 wherein the combined outer shape substantially corresponds to a shape of a logo, emblem, symbol or other object.

10. A graphic display according to claim 7 wherein the combined outer shape substantially corresponds to a shape of a real or fictitious person or a character.

11. A graphic display according to claim 7 wherein the combined outer shape substantially corresponds to an outer shape of a logo, emblem, or symbol designating a particular sports team or sports organization.

12. A graphic display according to claim 7 wherein the first and second sheets comprise a flexible polymeric material.

13. A graphic display according to claim 7 wherein the first and second sheets comprise vinyl.

14. A method of producing a multi-segment removable and reusable graphic display for a sectional overhead garage door of a type that includes at least first and second pivotally connected horizontal door panels separated by an elongated horizontal joint, the method comprising:
(a) providing a first sheet having a first magnetic face, an opposed first display face, and a first margin extending along a first edge portion of the first display face;
(b) printing a first pattern on the first display surface, wherein at least a portion of the first pattern is printed on at least a portion of the first margin;
(c) severing the first margin and a portion of the first pattern thereon from the first sheet to form a first severed edge, and trimming the first sheet to have a first shape;
(d) providing a second sheet having a second magnetic face, an opposed second display face, and a second margin extending along a second edge portion of the second display face;
(e) printing a second pattern on the second display surface, wherein at least a portion of the second pattern is printed on at least a portion of the second margin; and
(f) severing the second margin and a portion of the second pattern thereon from the second sheet to form a second severed edge, and trimming the second sheet to have a second shape;
(g) wherein when the first sheet is magnetically attached to a first outer face of the first door panel such that the first severed edge is proximate to the horizontal joint, and the second sheet is magnetically attached to a second outer face of the second door panel such that the second severed edge is proximate to the horizontal joint and the second sheet is aligned with the first sheet, the first and second shapes cooperate to form a combined outer shape and the remaining portions of the first and second patterns cooperate to form a substantially continuous combined pattern when the garage door is in a closed position.

15. A method according to claim 14 wherein the combined outer shape and the combined pattern depict a logo, emblem, symbol or other object.

16. A method according to claim 14 wherein the combined outer shape and the combined pattern depict a logo, emblem, or symbol of an organization, institution, or group.

17. A method according to claim 14 wherein the combined outer shape and the combined pattern depict a logo or emblem signifying a sports team or sports organization.

18. A method according to claim 14 wherein the first sheet and the second sheet comprise a flexible polymeric material.

19. A method according to claim 14 wherein the first sheet and the second sheet comprise vinyl.
